(19) United States
(12) Patent Application Publication
(10) Pub. No.: US 2014/0081884 A1
(43) Pub. Date: Mar. 20, 2014

(54) SYSTEMS AND METHODS OF PROVIDING A STREAMLINED REFERRAL FLOW

(71) Applicant: salesforce.com, inc., San Francisco, CA (US)

(72) Inventors: Ashwini Govindaraman, Hayward, CA (US); Stephanie Robotham, San Francisco, CA (US); Jenny Yoon, San Francisco, CA (US); Alan O'Connor, San Francisco, CA (US); Jayesh Sureshchandra, San Francisco, CA (US)

(73) Assignee: salesforce.com, inc., San Francisco, CA (US)

(21) Appl. No.: 14/028,311

(22) Filed: Sep. 16, 2013

Related U.S. Application Data
(60) Provisional application No. 61/701,496, filed on Sep. 14, 2012.
(60) Provisional application No. 61/804,492, filed on Mar. 22, 2013.

(51) Int. Cl. G06Q 10/10

(52) U.S. Cl. CPC G06Q 10/1053
USPC 705/321

(57) ABSTRACT

The technology disclosed further relates to efficiently referring recruiting candidates. In particular, it relates to providing a streamlined referral flow that enables a user to instantly refer a person whom the user has opportunistically met. The streamlined referral flow creates referral profiles of recruiting candidates based on commentary provided by a referrer and social data of the recruiting candidates assembled from one or more person-related data sources.

### RELATED APPLICATION

This application claims the benefit of two U.S. provisional Patent Applications, including: No. 61/701,496, entitled, “De-Duplicating Social Network Profiles to Build a Consolidated Social Profile,” filed 14 Sep., 2012 (SALE 1053-3/1030PROV); and No. 61/804,492, entitled, “Social Referrals,” filed 22 Mar., 2013 (SALE 1053-4/1133PROV). The provisional applications are hereby incorporated by reference for all purposes.

This application is related to US patent application entitled “Systems and Methods of Enriching CRM Data with Social Data,” (SALE 1053-5/1030US1) filed contemporaneously. The related application is incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In a job referral context, recruiters value personal referrals from their employees. With the advent of social networking systems, users are able to maintain social networks of friends and business acquaintances that number in the hundreds and even thousands. However, current recruitment systems have not adapted to fully realize the potential of recent technological advances.

An opportunity arises to make easy and comprehensive referrals of recruiting candidates. Improved user experience and engagement and higher customer satisfaction and retention may result.

### SUMMARY

The technology disclosed further relates to efficiently referring recruiting candidates. In particular, it relates to providing a streamlined referral flow that enables a user to instantly refer a person whom the user has opportunistically met. The streamlined referral flow creates referral profiles of recruiting candidates based on commentary provided by a referrer and social data of the recruiting candidates assembled from one or more person-related data sources.

Other aspects and advantages of the present technology can be seen on review of the drawings, the detailed description and the claims, which follow.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows example servers, clients, and databases used for providing a streamlined referral flow.

FIG. 2A is one implementation of a person token that uniquely identifies a recruiting candidate in a streamlined referral flow.

FIGS. 2B and 2C illustrate one implementation of an interface that accepts commentary about a recruiting candidate in a streamlined referral flow.

FIG. 3 shows one implementation of a referral profile of a recruiting candidate.

FIG. 4 illustrates one implementation of a referral profile schema of the referral profile shown in FIG. 3.

FIG. 5 illustrates a flowchart of one implementation of providing a streamlined referral flow.

FIG. 6 is a block diagram of an example computer system for providing a streamlined referral flow.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

The technology disclosed relates to providing a streamlined referral flow by using computer-implemented systems. The technology disclosed can be implemented in the context of any computer-implemented system including a database system, a multi-tenant environment, or the like. Moreover, this technology can be implemented using two or more separate and distinct computer-implemented systems that cooperate and communicate with one another. This technology may be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “specify” is used herein to mean the same as “identify.”

The technology disclosed can be applied to solve the technical problem of making efficient referrals of recruiting candidates. Companies and recruiters use a variety of sources to find appropriate candidates for their coveted positions. Traditionally, companies drew from a pool of viable applicants on career sites and job boards. Today, companies and recruiters are utilizing employee referrals to find the best qualified applicants. However, employee referral programs are time consuming and cumbersome and thus, the referrals are scarce and inadequate. The technology disclosed provides a streamlined referral flow that enables a user to instantly refer a person whom the user has opportunistically met. The streamlined referral flow creates a referral profile of a recruiting candidate based on the commentary provided by the referrer and social data of the recruiting candidate assembled from various person-related data sources. Finally, the referral profile can be included in a recruitment management system for review by recruiters.

### Servers, Clients, and Databases

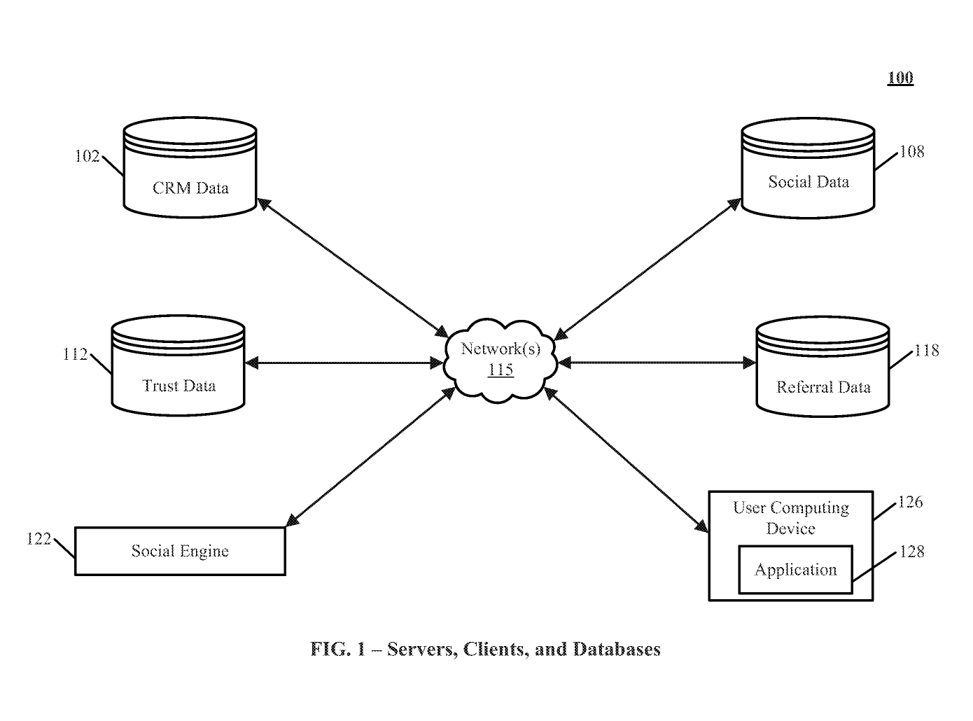

FIG. 1 shows example servers, clients, and databases 100 used for providing a streamlined referral flow. FIG. 1 includes CRM data 102, social data 108, trust data 112, and referral data 118. FIG. 1 also includes network(s) 115, social engine 122, user computing device 126, and application 128. In other implementations, servers, clients, and databases 100 may not have the same elements as those listed above and/or may have other/different elements instead of, or in addition to, those listed above such as a synchronization engine, a personalization engine, or an identification engine. The different elements can be combined into single software modules and multiple software modules can run on the same hardware.

In some implementations, network(s) 115 can be any one or any combination of Local Area Network (LAN), Wide Area Network (WAN), WiFi, telephone network, wireless network, point-to-point network, star network, token ring network, hub network, peer-to-peer connections like Bluetooth, Near Field Communication (NFC), Z-Wave, ZigBee, or other appropriate configuration of data networks, including the Internet.

In some implementations, the engine can be of varying types including workstations, servers, computing clusters, blade servers, server farms, or any other data processing systems or computing devices. The engine can be communicably coupled to the databases via a different network connection. For example, social engine 122 can be coupled via the network(s) 115 (e.g., the Internet), a direct network link, or a different network connection.

In some implementations, databases can store information from one or more tenants into tables of a common database image to form a multi-tenant database system (MTS). A database image can include one or more database objects. In other implementations, the databases can be relation database management systems (RDBMSs), object oriented database management systems (OODBMSs), distributed file systems (DFS), no-schema database management systems, or any other data storing systems or computing devices.

User computing device 126 can be a personal computer, laptop computer, tablet computer, smartphone, personal digital assistant (PDA), digital image capture devices, and the like. Application 128 can take one of a number of forms, including user interfaces, dashboard interfaces, engagement consoles, and other interfaces, such as mobile interfaces, tablet interfaces, summary interfaces, or wearable interfaces. In some implementations, it can be hosted on a web-based or cloud-based application running on the user computing device 126. It can also be hosted on a non-social local application running in an on-premise environment. In one implementation, it can be accessed from a browser running on a computing device. The browser can be Chrome, Internet Explorer, Firefox, Safari, and the like. In other implementations, application 128 can run as engagement consoles on a computer desktop application.

CRM data 102 includes various entities (persons and organizations) such as prospects, leads, and/or accounts and further provides business information related to the respective entities. Examples of business information can include: names, addresses, job titles, number of employees, industry types, territories, market segments, contact information, employer information, stock rate, etc. In one implementation, CRM data 102 can store web or database profiles of the users and organizations as a system of interlinked hypertext documents that can be accessed via the network(s) 115 (e.g., the Internet). In another implementation, CRM data 102 can also include standard profile information about persons and organizations. This standard profile information can be extracted from company websites, business registration sources such as Jigsaw, Hoovers, or Dun & Bradstreet, business intelligence sources, and/or social networking websites like Yelp, Yellow Pages, etc.

In one implementation, CRM data 102 can include business-to-business data of individuals referred to as “contacts,” along with some supplemental information. This supplemental information can be names, addresses, job titles, usernames, contact information, employer name, etc.

Regarding different types of person-related data sources, access controlled application programing interfaces (APIs) like Yahoo Boss, Facebook Open Graph, Twitter Firehose can provide real-time search data aggregated from numerous social media sources such as LinkedIn, Yahoo, Facebook, and Twitter. APIs can initialize sorting, processing, and normalization of data.

Public Internet can provide data from public sources such as first hand websites, blogs, web search aggregators, and social media aggregators. Social networking sites can provide data from social media sources such as Twitter, Facebook, LinkedIn, and Klout.

Social engine 122 spiders various person-related data sources to retrieve social data 108 related to CRM data 102, including web data associated with the business-to-business contacts. In some implementations, social engine 122 can extract a list of contacts from a master database and search those contacts on the various person-related data sources in order to determine if social or web content associated with the contacts exists within those platform. If the person-related data sources provide positive matches to any of the contacts, the social engine 122 can store the retrieved social or web content as social data 108.

Social data 108 stores social media content assembled from different types of person-related data sources. Social media content can include information about social media sources, social accounts, social personas, social profiles, social handles, etc. of the business-to-business contacts stored in CRM data 102.

In some implementations, social data 108 can include a feed that is a combination (e.g. a list) of feed items. A feed item or feed element can include information about a user of the database referred to as profile feed or about a record referred to as record feed. A user following the user or record can receive the associated feed items. The feed items from all of the followed users and records can be combined into a single feed for the user. The information presented in the feed items can include entries posted to a user's wall or any other type of information accessible within the social network platform. For example, a user's news feed can include text inputs such as comments (e.g., statements, questions, and emotional expressions), responses to comments (e.g., answers, reactionary emotional expressions), indications of personal preferences, status updates, and hyperlinks. As another example, a news feed can include file uploads, such as presentations, documents, multimedia files, and the like.

In some implementations, the trust of assembled social data 108 can be enhanced by appending trust tags (stored as trust data 112) to various data objects in social data 108. The trust tags include names of the person-related data sources, interface categories of the person-related data sources, jurisdictional origins of the person-related data sources, and engagement preferences of the recruiting candidates.

The interface categories of the person-related data sources include access controlled APIs, public Internet, and social networking sites. The jurisdictional origins of the person-related data sources specify engagement rules applicable to geographic locations of the social network platforms. The engagement preferences of the recruiting candidates specify whether the recruiting candidates have opted-in or opted-out of any use of their social identification information.

Social engine 122 retrieves recruitment-valuable attributes or characteristics of the recruiting candidates from social data 108 by applying semantic analysis and keyword extraction to at least one of: information specified in social profiles of the recruiting candidates, text of feed items posted by the recruiting candidates, and/or content uploaded on career sites by the recruiting candidates. The retrieved recruitment-valuable attributes or characteristics are stored as referral data 118. The semantic analysis can include recruitment-valuable keywords (also stored as referral data 118) associated with one or more user characteristics in the social profiles and further assigns each recruitment-valuable keyword a value. The value of each identified recruitment-valuable keyword is then used to calculate a score for the user characteristic to which the recruitment-valuable keyword is correlated.

In other implementations, social engine 122 identifies preferences and interests of the recruiting candidates by counting the number of occurrences of certain preferences and interests keywords within the text of feed items posted by the recruitment candidates and the number of postings of the feed items including the preferences and interests keywords.

Referral data 118 holds referral profiles of recruiting candidates created by combining commentary entered by the referrers about the recruiting candidates and social data 108 of the recruiting candidates assembled from a plurality of person-related data sources. In some implementations, referral data 118 includes person tokens that uniquely identify the recruiting candidates.

### Streamlined Referral Flow

Personal referrals are an effective source for recruiting potential candidates for job openings. Personal referrals are valuable because they create a connection between an employer and the recruiting candidate that an application from an unknown or non-recommended individual may not provide. Typically, platforms that allow employees to refer candidates for open positions are time consuming and cumbersome as they require myriad of information from the employees.

Moreover, current job referral programs do not identify passive candidates because these programs do not have the ability to locate such candidates and communicate with them. These referral programs require busy employees to go over multiple hops before they can make a referral. These steps include routinely looking through job listings, filtering address books to identify friends and former colleagues who would be a good fit, making initial contacts, entering large volumes of information in complex forms, following up with the candidates throughout the referral process, and repeating this process for every referral.

Referral flow 200 enables employees to bypass many of the steps described above, and therefore increases the number of referrals. In some implementations, it allows employees to make “on the go” referrals of individuals whom they have opportunistically met. For instance, if an employee, while attending a conference, finds another attendee to be a good fit for his company, the employee can use referral flow 200 to make an instant referral of the individual through his mobile device. As a result, referral flow 200 can assemble personal-related information about the individual from various person-related data sources and combine it with the commentary provided by the employee to automatically create a comprehensive referral profile. This referral profile identifies various attributes of the individual, some of which are described in the “Referral Profile” section of this application. In other implementations, referral flow 200 can include crawling recruitment sites like Monster.com, Ineed.com, and the like to retrieve resumes, cover letters, transcripts, and other recruitment-specific information about the individual.

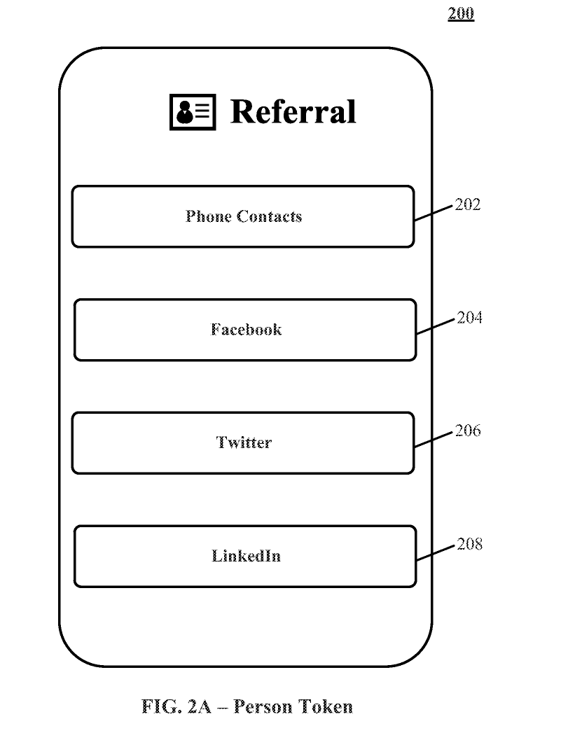

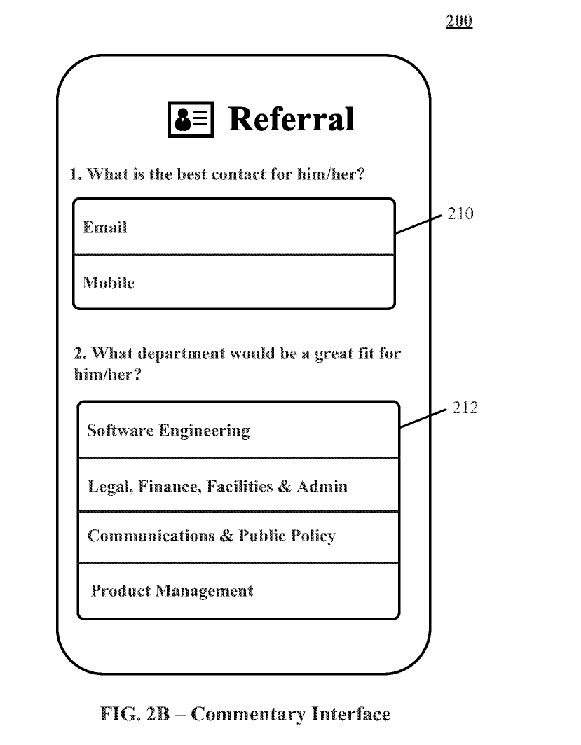

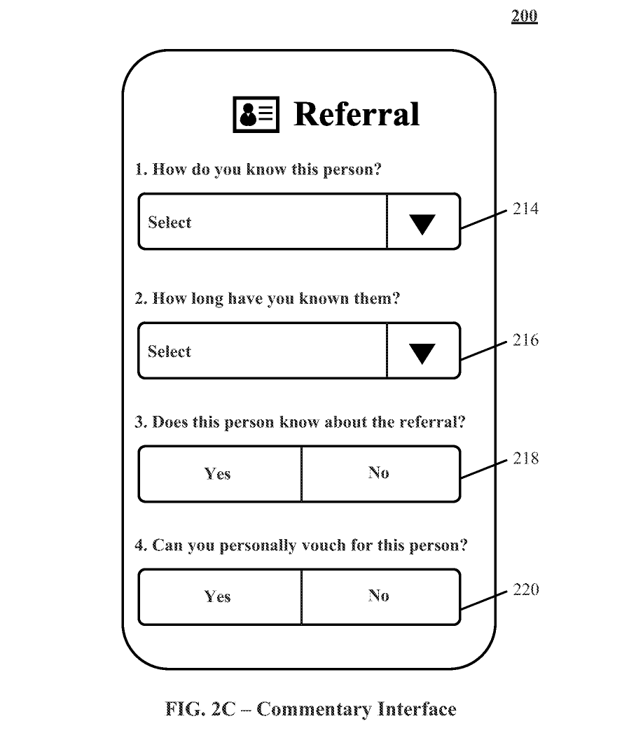

FIG. 2A is one implementation of a person token that uniquely identifies a recruiting candidate in the referral flow 200. In some implementations, the person token can be a business contact 202 that represents the recruiting candidate on a business contact directory such as iContacts, Outlook Contacts, Gmail Contacts, Jigsaw, or Dun & Bradstreet. In other implementations, the person token can be a social handle (Facebook username 204, Twitter handle 206, and LinkedIn link 208) of a social account that represents the recruiting candidate on a social network platform like Facebook, Twitter, or LinkedIn.

FIGS. 2B and 2C illustrate one implementation of an interface that accepts commentary about the recruiting candidate in the referral flow 200. In some implementations, interface 2B can include screen object 210 to receive contact information of the recruiting candidate and screen object 212 to receive specification of most fitting departments for the recruiting candidate. In other implementations, interface 2C can include screen objects 214, 216, 218 and 220 to respectively identify how the user knows the recruiting candidate, length of time the user has known the recruiting candidate, whether the recruiting candidate knows about the referral, and if the user can personally vouch for the recruiting candidate's work ethic. Responses to these questions can be simple yes or no answers, a selection among a predetermined list of responses, a rating scale, a text field, an open ended response, and so on.

### Referral Profile

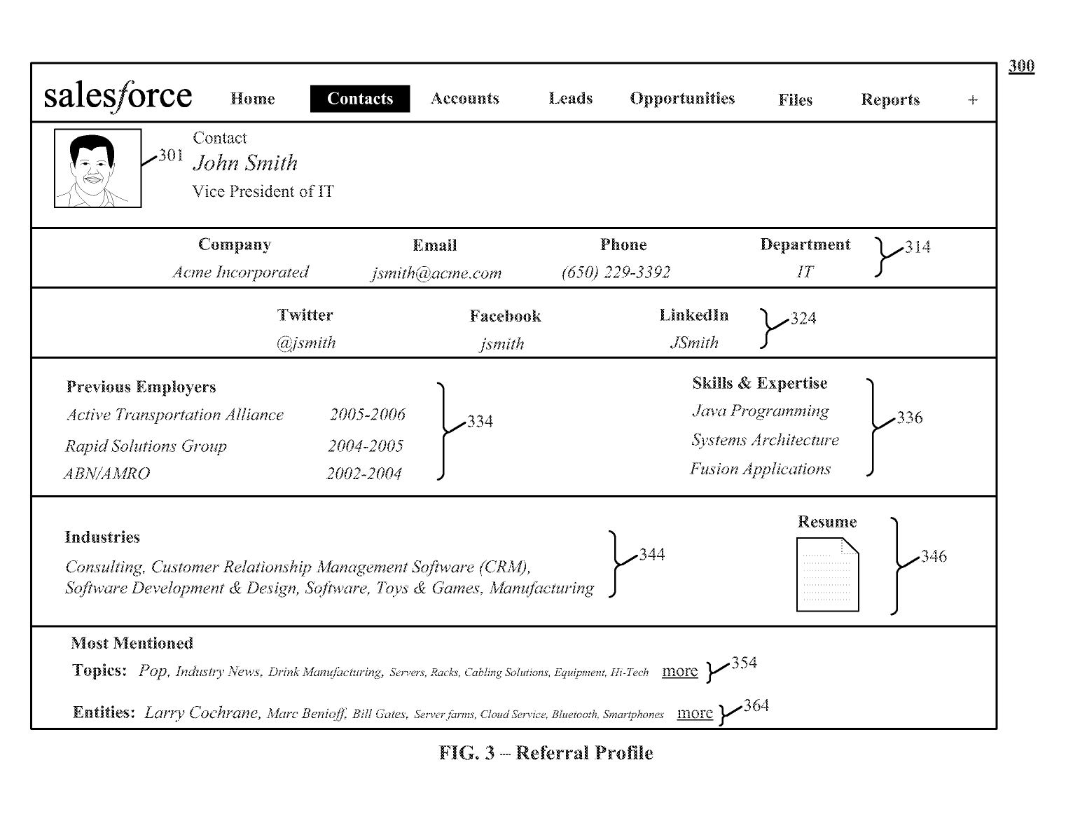

FIG. 3 shows one implementation of a referral profile 300 of a recruiting candidate 301 named ‘John Smith’. Referral profile 300 includes biographic information 314 of the recruiting candidate 301, social handle information 324 of the recruiting candidate 301, recruiting candidate's employment history 334, skills and expertise 336 of the recruiting candidate 301, one or more industries the recruiting candidate works in 344, one or more resumes 346 of the recruiting candidate 301, and topics 354 and entities 364 that the recruiting candidate 301 is interested in. In other implementations, referral profile 300 may not have the same screen objects, interfaces, or widgets as those listed above and/or may have other/different screen objects, interfaces, or widgets instead of, or in addition to, those listed above such as connections and colleagues of the recruiting candidate 301, social influence of the recruiting candidate 301, etc. The different elements can be combined into single software modules and multiple software modules can run on the same hardware.

### Referral Profile Schema

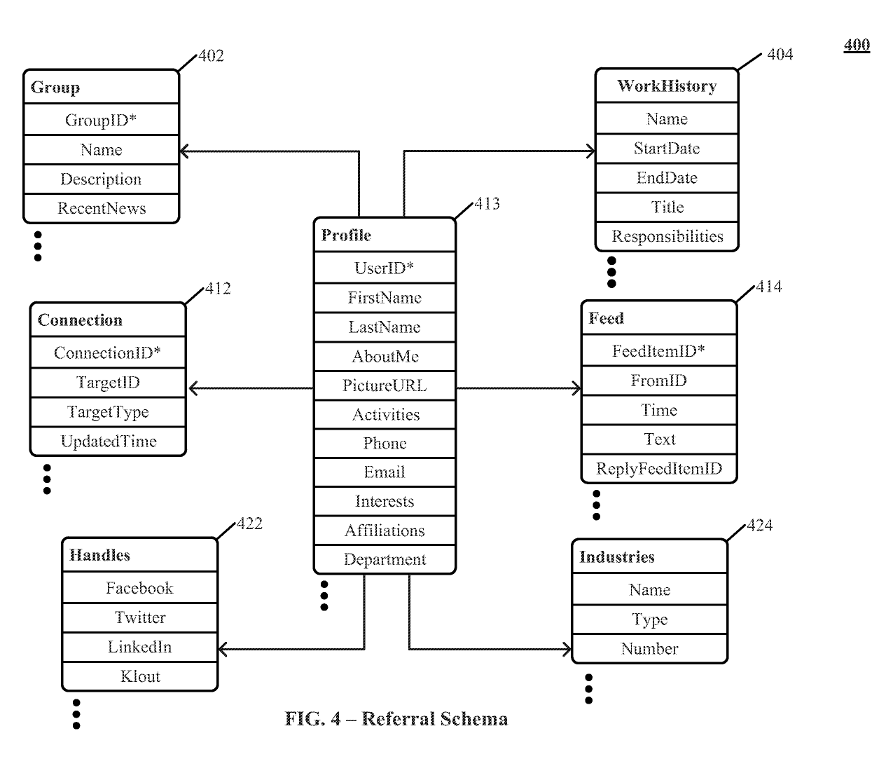

FIG. 4 illustrates one implementation of a referral profile schema 400 of the referral profile 300 shown in FIG. 3. This and other data structure descriptions that are expressed in terms of objects can also be implemented as tables that store multiple records or object types. Reference to objects is for convenience of explanation and not as a limitation on the data structure implementation. FIG. 4 shows a profile object 413 linked to group object 402, work history object 404, connection object 412, feed object 414, handles object 422, and industries object 424. In other implementations, social data schema 400 may not have the same objects, tables, fields or entries as those listed above and/or may have other/different objects, tables, fields or entries instead of, or in addition to, those listed above such as a topic object, interest object, or contact information object.

Profile object 413 provides primary information that identifies the recruiting candidate 301 and includes various fields that store biographic information about the recruiting candidate 301 such as first name, last name, sex, birthday, department, interests, etc. In some implementations, the profile object 413 can be further linked to other objects that provide supplementary information about the recruiting candidate 301. For instance, profile object 413 can be linked to a group object 402 that identifies the groups the recruiting candidate 301 is part of. In one implementation, profile object 413 can be linked to a connection object 412 228 that provides information about other users in the social network of the recruiting candidate 301.

In one implementation, profile object 413 can be linked to at least one of: a work history object 404 that specifies past employers of the recruiting candidate 301, along with employment start and end dates, job titles, and job responsibilities; a handles object 422 that identifies social handles of the recruiting candidate 301 on various person-related data sources like Facebook, Twitter, LinkedIn, and/or Klout; a feed object 414 that specifies various feeds items such as posts, comments, replies, mentions, etc. posted by the recruiting candidate 301 or on social profiles of the recruiting candidate 301; and an industries objects 424 that includes the name, type, and reference number of industries the recruiting candidate 301 works in.

In yet another implementation, schema 400 can have one or more of the following variables with certain attributes: USER_ID being CHAR (15 BYTE), CONNECTION_ID being CHAR (15 BYTE), GROUP_ID being CHAR (15 BYTE), INDUSTRY_ID being CHAR (15 BYTE), TAG_FORMAT_ID being CHAR (15 BYTE), FEED_ITEM_ID being CHAR (15 BYTE), CREATED_BY being CHAR (15 BYTE), CREATED_DATE being DATE, and DELETED being CHAR (1 BYTE).

### Flowchart of Streamlined Referral Flow

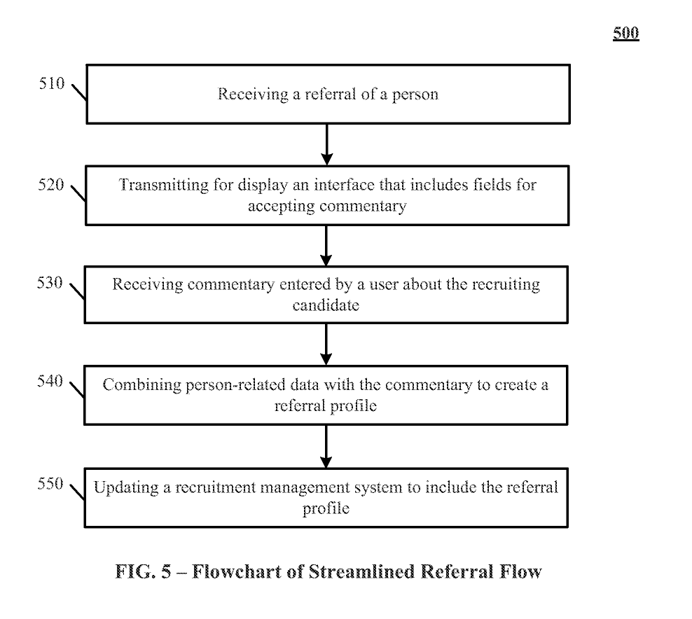

FIG. 5 illustrates a flowchart 500 of one implementation of providing a streamlined referral flow. Flowchart 500 can be implemented at least partially with a database system, e.g., by one or more processors configured to receive or retrieve information, process the information, store results, and transmit the results. Other implementations may perform the actions in different orders and/or with different, fewer or additional actions than the ones illustrated in FIG. 5. Multiple actions can be combined in some implementations. For convenience, this flowchart is described with reference to the system that carries out a method. The system is not necessarily part of the method.

At action 510, a referral is received of a person that a user has opportunistically met and that the user endorses as a recruiting candidate. The referral includes at least one person token that uniquely identifies the recruiting candidate. In some implementations, the person token is a link to a social account that represents the recruiting candidate on a social network platform. In other implementations, the person token is a business contact that represents the recruiting candidate on a business contact directory.

At action 520, an interface is transmitted that includes fields for accepting commentary about the recruiting candidate and user's relationship with the recruiting candidate. In other implementations, commentary can be accepted by other user commit behaviors that can be executed by a voice, visual, physical, or text command. Examples of other user commit behaviors can include: speaking in a microphone, blinking of eye across an eye tracking device, moving a body part across a motion sensor, pressing a button on a device, selecting a screen object on an interface, or entering data across an interface.

At action 530, commentary entered by the user about the recruiting candidate is received. In some implementations, commentary includes contact information of the recruiting candidate, specification of most fitting departments for the recruiting candidate, and data that identifies: how the user knows the recruiting candidate, length of time the user has known the recruiting candidate, whether the recruiting candidate knows about the referral, and if the user can personally vouch for the recruiting candidate's work ethic.

At action 540, person-related data for the recruiting candidate from a plurality of person-related data sources is combined with the commentary to create a referral profile of the recruiting candidate. Person-related data include social data 108 and refer to social media content assembled from different types of person-related data sources. Social media content can include information about social media sources, social accounts, social personas, social profiles, social handles, etc. of the recruiting candidate. In some implementations, person-related data can include a feed that is a combination (e.g. a list) of feed items. A feed item or feed element can include information about the recruiting candidate referred to as profile feed. In other implementations, person-related data include recruitment-specific data (resumes, cover letters, transcripts) extracted from career sites like Monster.com, Indeed.com, and the like.

At action 550, a recruitment management system is updated to include the referral profile. In some implementations, a specification can be received from the user that identifies a destination email address or data repository for forwarding the referral profile.

### Computer System

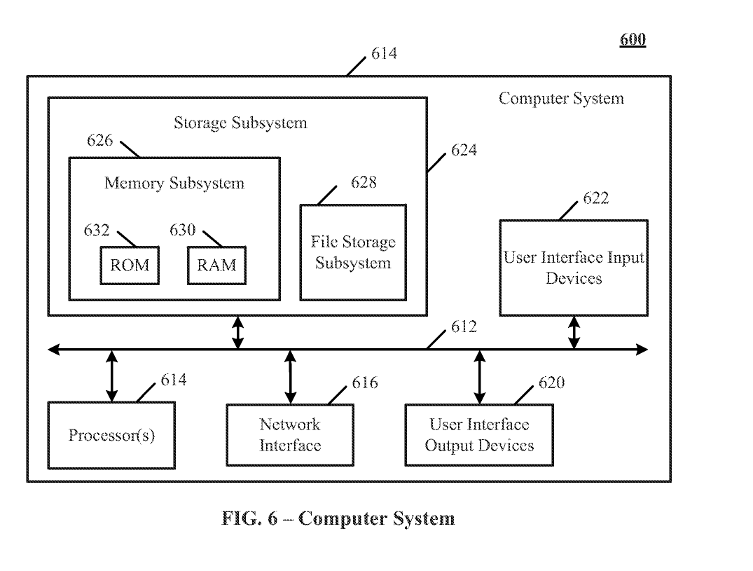

FIG. 6 is a block diagram of an example computer system 600 for providing a streamlined referral flow. FIG. 6 is a block diagram of an example computer system, according to one implementation. Computer system 610 typically includes at least one processor 614 that communicates with a number of peripheral devices via bus subsystem 612. These peripheral devices can include a storage subsystem 624 including, for example, memory devices and a file storage subsystem, user interface input devices 622, user interface output devices 620, and a network interface subsystem 616. The input and output devices allow user interaction with computer system 610. Network interface subsystem 616 provides an interface to outside networks, including an interface to corresponding interface devices in other computer systems.

User interface input devices 622 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 610.

User interface output devices 620 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules and methods described herein. These software modules are generally executed by processor 614 alone or in combination with other processors.

Memory 626 used in the storage subsystem can include a number of memories including a main random access memory (RAM) 630 for storage of instructions and data during program execution and a read only memory (ROM) 632 in which fixed instructions are stored. A file storage subsystem 628 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 628 in the storage subsystem 624, or in other machines accessible by the processor.

Bus subsystem 612 provides a mechanism for letting the various components and subsystems of computer system 610 communicate with each other as intended. Although bus subsystem 612 is shown schematically as a single bus, alternative implementations of the bus subsystem can use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as one example. Many other configurations of computer system 610 are possible having more or fewer components than the computer system depicted in FIG. 6.

### Particular Implementations

In one implementation, a method is described from the perspective of a server receiving messages from user software. The method includes providing a streamlined referral flow using a server in communication with a mobile application that receives a referral of a person that a user has opportunistically met that the user endorses as a recruiting candidate. The referral includes at least one person token that uniquely identifies the recruiting candidate. The streamlined referral flow also transmits for display an interface that includes fields for accepting commentary about the recruiting candidate and user's relationship with the recruiting candidate. The streamlined referral flow also receives commentary entered by the user about the recruiting candidate and combines person-related data for the recruiting candidate from a plurality of person-related data sources with the commentary to create a referral profile of the recruiting candidate. The method further includes updating a recruitment management system to include the referral profile.

This method can be presented from the perspective of a mobile device and user software interacting with a server. From the mobile device perspective, the method includes receiving a referral of a person that a user has opportunistically met that the user endorses as a recruiting candidate. The referral includes at least one person token that uniquely identifies the recruiting candidate. The method includes transmitting for display an interface across the mobile device that includes fields for accepting commentary about the recruiting candidate and user's relationship with the recruiting candidate. The method also includes receiving commentary entered by the user about the recruiting candidate through the mobile device and further relies on the server to combine person-related data for the recruiting candidate from a plurality of person-related data sources with the commentary to create a referral profile of the recruiting candidate. The method further includes updating a recruitment management system to include the referral profile.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as streamlined referral flow, referral profile, or referral profile schema.

The person token is a link to a social account that represents the recruiting candidate on a social network platform. The person token is also a business contact that represents the recruiting candidate on a business contact directory.

The fields for accepting commentary about the recruiting candidate enable the user to specify at least contact information of the recruiting candidate, most fitting departments for the recruiting candidate, how the user knows the recruiting candidate, length of time the user has known the recruiting candidate, and whether the recruiting candidate knows about the referral.

The person-related data include biographic information about the recruiting candidate, recruitment-specific information about the recruiting candidate such as resumes and cover letters, employment history of the recruiting candidate, one or more industries the recruiting candidate works in, and skills and expertise of the recruiting candidate.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

1. A method, including:
providing a streamlined referral flow using a server in communication with a mobile application that
receives a referral of a person that a user has opportunistically met and that the user endorses as a recruiting candidate, wherein the referral includes at least one person token that uniquely identifies the recruiting candidate;
transmits for display an interface that includes fields for accepting commentary about the recruiting candidate and user's relationship with the recruiting candidate;
receives commentary entered by the user about the recruiting candidate; and
combines person-related data for the recruiting candidate from a plurality of person-related data sources with the commentary to create a referral profile of the recruiting candidate; and
updating a recruitment management system to include the referral profile.

2. The method of claim 1, wherein the person token is a link to a social account that represents the recruiting candidate on a social network platform.

3. The method of claim 1, wherein the person token is a business contact that represents the recruiting candidate on a business contact directory.

4. The method of claim 1, wherein the fields for accepting commentary about the recruiting candidate enable the user to specify at least:
contact information of the recruiting candidate;
most fitting departments for the recruiting candidate;
how the user knows the recruiting candidate;
length of time the user has known the recruiting candidate; and
whether the recruiting candidate knows about the referral.

5. The method of claim 1, wherein the referral profile includes biographic information about the recruiting candidate.

6. The method of claim 1, wherein the referral profile includes at least employment history and skills and expertise of the recruiting candidate.

7. The method of claim 1, wherein the referral profile identifies one or more industries the recruiting candidate works in.

8. The method of claim 1, wherein the referral profile includes one or more resumes of the recruiting candidate.

9. The method of claim 1, wherein the referral profile specifies skills and expertise of the recruiting candidate.

10. The method of claim 1, wherein the referral profile identifies topics and entities that interest the recruiting candidate.

11. A system, including:
a processor and a computer readable storage medium storing computer instructions configured to cause the processor to:
provide a streamlined referral flow using a server in communication with a mobile application that
receives a referral of a person that a user has opportunistically met and that the user endorses as a recruiting candidate, wherein the referral includes at least one person token that uniquely identifies the recruiting candidate;
transmits for display an interface that includes fields for accepting commentary about the recruiting candidate and user's relationship with the recruiting candidate;
receives commentary entered by the user about the recruiting candidate; and
combines person-related data for the recruiting candidate from a plurality of person-related data sources with the commentary to create a referral profile of the recruiting candidate; and
update a recruitment management system to include the referral profile.

12. The system of claim 11, wherein the person token is a link to a social account that represents the recruiting candidate on a social network platform.

13. The system of claim 11, wherein the person token is a business contact that represents the recruiting candidate on a business contact directory.

14. The system of claim 11, wherein the fields for accepting commentary about the recruiting candidate enable the user to specify at least:
contact information of the recruiting candidate;
most fitting departments for the recruiting candidate;
how the user knows the recruiting candidate;
length of time the user has known the recruiting candidate; and
whether the recruiting candidate knows about the referral.

15. The system of claim 11, wherein the referral profile includes biographic information about the recruiting candidate.

16. The system of claim 11, wherein the referral profile includes at least employment history and skills and expertise of the recruiting candidate.

17. The system of claim 11, wherein the referral profile identifies one or more industries the recruiting candidate works in.

18. The system of claim 11, wherein the referral profile includes one or more resumes of the recruiting candidate.

19. The system of claim 11, wherein the referral profile specifies skills and expertise of the recruiting candidate.

20. The system of claim 11, wherein the referral profile identifies topics and entities that interest the recruiting candidate.
